(19) United States
(12) Patent Application Publication
(10) Pub. No.: US 2014/0214618 A1
(43) Pub. Date: Jul. 31, 2014

(54) IN-STORE CUSTOMER SCAN PROCESS INCLUDING NUTRITIONAL INFORMATION

(71) Applicant: WAL-MART STORES, INC., Bentonville, AR (US)

(72) Inventors: Douglas James Pedley, Portland, OR (US); Richard Neil Cancro, Portland, OR (US); Joel Bennett Acker, JR., Brush Prairie, WA (US)

(73) Assignee: Wal-Mart Stores, Inc., Bentonville, AR (US)

(21) Appl. No.: 13/754,751

(22) Filed: Jan. 30, 2013

(51) Int. Cl. G06Q 30/06

(52) U.S. Cl. CPC G06Q 30/0623
USPC 705/26.61

(57) ABSTRACT

A computer-implemented process can be implemented to provide a customer with nutritional information about an item to be purchased. The process includes monitoring a scan of the item to be purchased within a processor of a portable computerized device. The process further includes automatically referencing a remote database to identify nutritional information for the item to be purchased and displaying the nutritional information to the customer upon a display of the portable computerized device.

### BACKGROUND INFORMATION

1. Field of the Disclosure

The present disclosure relates generally to a computer implemented process to allow customers to use a portable computerized device to scan goods in a store and allow them to purchase the item. In particular, examples of the present disclosure are related to referencing nutritional information for items selected for purchase and presenting the information to the customer.

2. Background

Portable computerized devices permit a user to collect and process data from surroundings. A portable computerized device can include a camera device configured to capture an image or a series of images which can collectively be defined as a video feed. Programming upon or accessible by the device can process the image or images to identify useful information. The device can include wireless communication to acquire or send information to a remote server device. A device can additionally or alternatively include a microphone to record audio.

Augmented reality includes software applications that superimpose computer-generated images upon a view of the real world. In one embodiment, augmented reality can be operated upon a smart-phone, a tablet computer, or other similar portable device.

Augmented reality can provide computer generated graphical images superimposed upon a visual scene of an area proximate to the viewer. In combination with image recognition and programming permitting identification of features in a view, graphical images can be projected to identify an object of interest in the view. Graphical images can be configured to interact in an amusing way or otherwise entertain the viewer. Graphical images can provide instruction or augment the view with supplemental information. By superimposing images upon a view of objects in the real world, the experience of the viewer can be enhanced with information, entertainment, or other graphical content.

A portable computerized device can include software applications that capture product barcodes, QR codes, images of packaging details, or other identifying marks, and by matching these marks to those in a centralized database, identify the product so that it can then be later used.

### BRIEF DESCRIPTION OF THE DRAWINGS

Non-limiting and non-exhaustive embodiments of the present disclosure are described with reference to the following figures, wherein like reference numerals refer to like parts throughout the various views unless otherwise specified.

FIG. 1 is a schematic illustrating an exemplary portable computerized device in communication with an exemplary store product index server, according to some embodiments of the disclosure;

FIG. 2 is an illustration of a product on a shelf being scanned by an exemplary portable computerized device, according to some embodiments of the disclosure;

FIG. 3 is an exemplary display of a portable computerized device providing information to a user regarding nutritional information for a scanned item, according to some embodiments of the disclosure;

FIGS. 4A and 4B schematically illustrate exemplary portable computerized devices utilizing the processes disclosed herein, according to some embodiments of the disclosure;

FIG. 4A is a schematic illustrating an exemplary portable computerized device embodied as a smart phone; and

FIG. 4B is a schematic illustrating an exemplary portable computerized device embodied as a tablet computer;

FIG. 5 is an exemplary computer display showing a customer shopping profile and various options for the customer regarding setting dietary or nutritional goals and for requesting suggestions regarding substitutions that can be made for scanned items, according to some embodiments of the disclosure;

FIG. 6 is a schematic illustrating an exemplary store product index server, according to some embodiments of the disclosure;

FIG. 7 is a schematic illustrating an exemplary portable computerized device configured to implement processes disclosed herein, according to some embodiments of the disclosure; and

FIG. 8 is a flowchart illustrating an exemplary process to provide nutritional information and suggested substitutions to a user, according to some embodiments of the disclosure.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments of the present disclosure.

### DETAILED DESCRIPTION

In the following description, numerous specific details are set forth in order to provide a thorough understanding of the present disclosure. It will be apparent, however, to one having ordinary skill in the art that the specific detail need not be employed to practice the present disclosure. In other instances, well-known materials or processes have not been described in detail in order to avoid obscuring the present disclosure.

Reference throughout this specification to “one embodiment”, “an embodiment”, “one example” or “an example” means that a particular feature, structure or characteristic described in connection with the embodiment or example is included in at least one embodiment of the present disclosure. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

A process for improving a shopping experience of a customer can include a customer scan and rapid checkout process. In one exemplary embodiment, a shopper can use a portable computerized device, such as a smart phone, a tablet computer, or glasses equipped with a processing device and configured to project images in a view of the user, and more particularly, a camera device equipped to the device, to scan items for purchase. These scanned items can be added to an electronic billing statement, the items can be placed in the shopping cart, and a rapid or abbreviated checkout process can be utilized to permit the shopper to pay and go, thereby skipping long lines at a cashier-manned checkout station or the hassle of a self-scan checkout. such an abbreviated checkout process can include the customer paying the electronic billing statement and then being permitted to leave the store.

In order to permit the customer to scan an item and add it to an electronic billing statement, the item need to be identified as a product within a database, for example, to provide a price for the item. In such a database, additional information can be stored in relation to the product. According to one embodiment, nutritional information for the product can be stored and referenced.

Nutritional or dietary guidelines are widely published and can be used to promote healthy choices. Exemplary healthy choices that can be made include avoiding excessive calories, avoiding excessive sodium, and eating a recommended amount of dietary fiber. Such choices can be expressed by daily targets or daily limits that the person should follow.

Nutritional information can be accessed by customer on printed labels available on most food and drink. However, such information must be read by the customer in order for the information to be useful. A process to present such nutritional information to the customer during the shopping process on a screen a a device being used to scan items for purchase can increase access of the customer to the information in real-time and increase a likelihood that the customer will act upon the information. Further, information in a database can be used to provide suggested substitutions for scanned items.

A consumer can use standard or generic guidelines in setting dietary guidelines or criteria for offering substitutions. According to one example, a recommended daily calorie intake of 2,000 calories can be used. In another embodiment, the consumer can add customized settings to guidelines and criteria. In one embodiment, a user could be preconfigured with a proprietary diet program. For example, when a customer scans a product, the calories, points, or other means for measuring diet and nutrition could be automatically counted and tallied. In another example, the proprietary diet program could indicate to the customer if a product has been scanned that contains ingredients that have been strictly forbidden in the diet, such as carbohydrates.

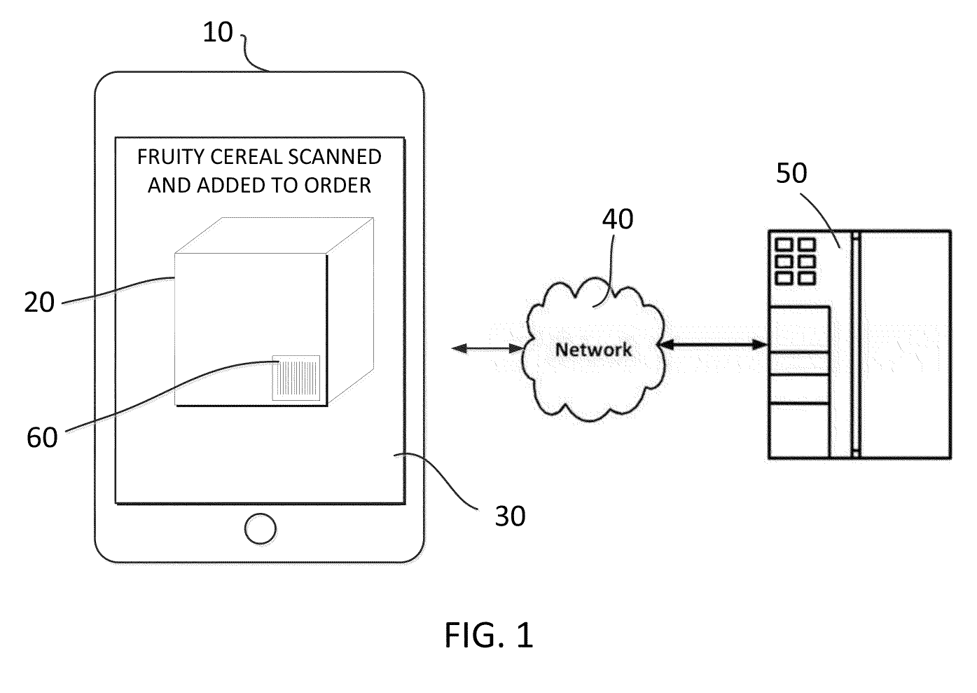

To illustrate, FIG. 1 is a schematic illustrating an exemplary portable computerized device in communication with an exemplary store product index server. Portable computerized device 10 is illustrated, including view 30 displayed upon a graphical user interface of device 10. Included within view 30 is product 20 with UPC symbol 60. Device 10 can include a camera device, and an image or a series of images creating a video fees can be displayed including an item being purchased by the user. Device 10 is an exemplary portable computerized device including input devices configured to gather information and a processor configured to make determinations regarding data from the input devices. Store product index server 50 is illustrated including a remote computerized system with modules operating to share information gathered from device 10 with other possible servers in a network as discussed herein. Server 50 and device 10 are in communication through exemplary wireless communications network 40.

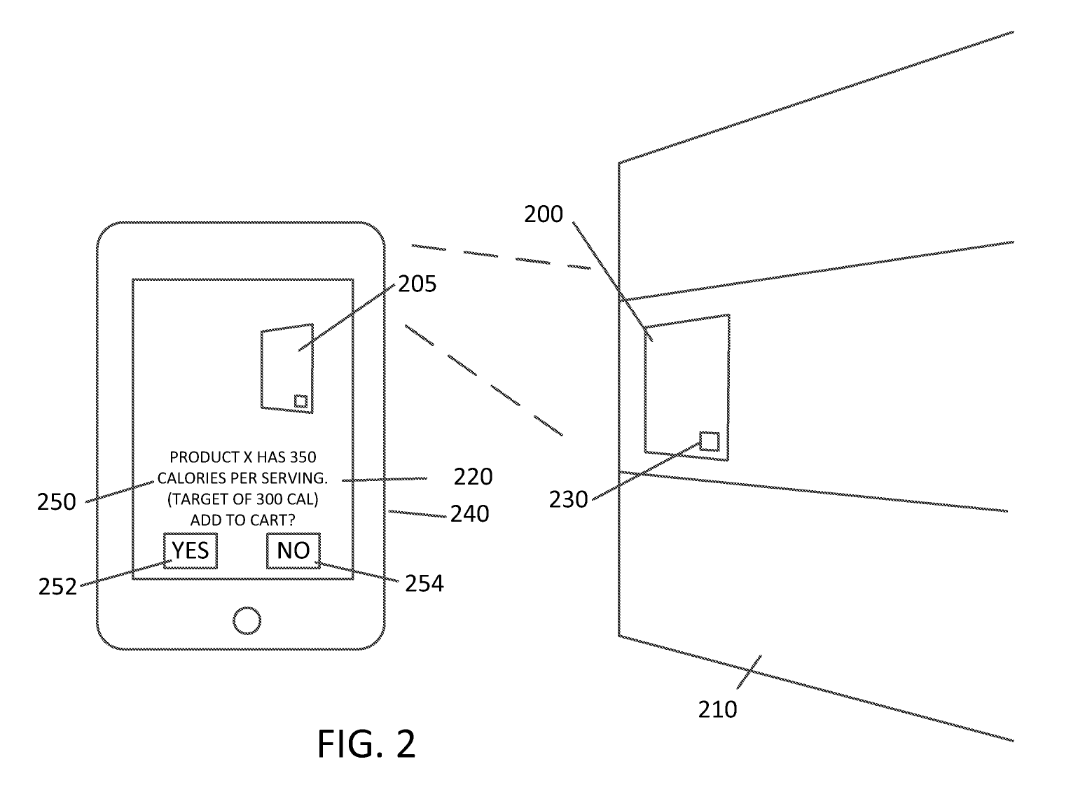

FIG. 2 is an illustration of a product on a shelf being scanned by an exemplary portable computerized device. Product 200 is situated on shelf 210. Product 200 can be scanned and identified by an identifying barcode, for example, a universal product code (UPC) symbol 230, using an exemplary camera device installed to portable computerized device 240. View 220 including an image 205 of product 200 can be projected upon portable computerized device 240. Further view 220 can include graphics, as an exemplary augmented reality program, projected upon the view 220. Based upon the scanned symbol 230, a remote database can be accessed and information about a product associated with the symbol can be referenced. In the illustrated embodiment of FIG. 2, a number of calories per serving of product 200 has been referenced (350 in this example,) the number of calories has been cross-referenced to a preference of the user (that products are preferred to have 300 calories per serving in this example,) and message 250 prompts the user to make a decision based upon presented information. Buttons 252 and 254 are presented, requesting input from the user as to whether the item should be added to the user's cart despite the provided information. As illustrated in FIG. 2, a customer can set a per item calorie count target or a product type specific calorie target, e.g., for anything that can be labeled a snack, set a calorie target of 100 calories, or for anything that can be labeled as a lunch entree, set a calorie target of 300 calories. In such an example, a scanned item can include type labels in a database in order to classify the scanned item and permit it to be matched with a target calorie count for a customer.

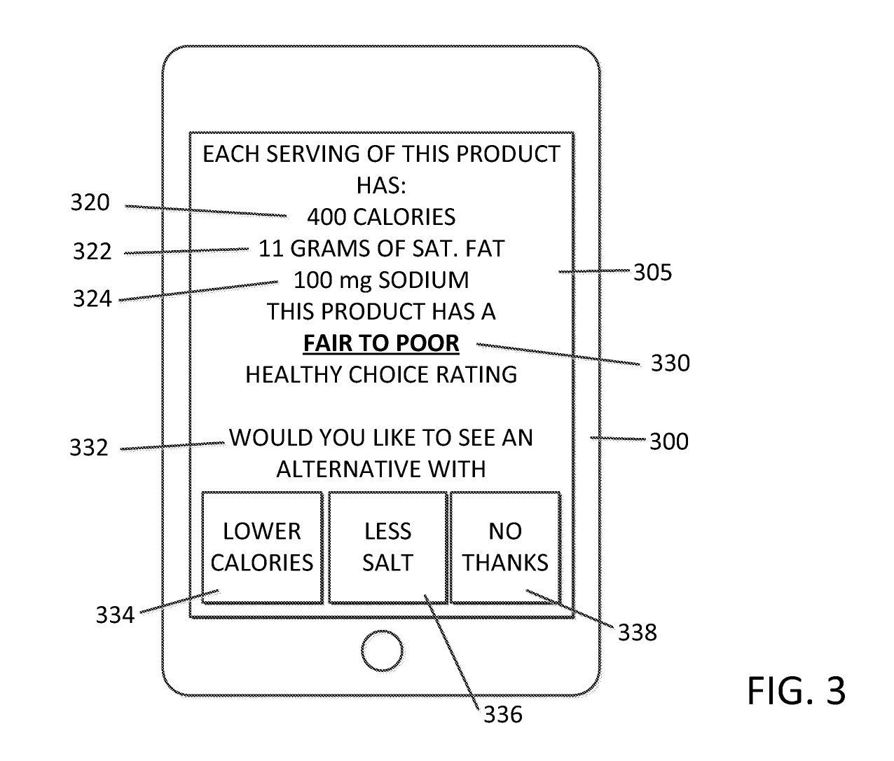

FIG. 3 is an exemplary display of a portable computerized device providing information to a user regarding nutritional information for a scanned item. Device 300 includes graphical user interface 305. Nutritional details 320, 322, and 324 provide per serving nutritional information related to the scanned product regarding calories, fat content, and sodium content, respectively. An analysis of the product can be performed based upon nutritional goals of the user, based upon generic nutritional guidelines, or stored generically for a product based upon input from a nutrition or health expert. Results of the analysis of the product are displayed in message 330, explaining to the user that the exemplary product has a “fair to poor healthy choice rating,” perhaps conveying to the customer that while the product is not the worst nutritional choice in the store, it is also not the best, and that a substitution might be warranted. Message 332 is provided encouraging the customer to request an alternative according to choices provided upon buttons 334 or 336, providing options for lower calorie or lower salt options, respectively. Button 338 is provided giving the customer the option to say “no thanks” and keep the already scanned item.

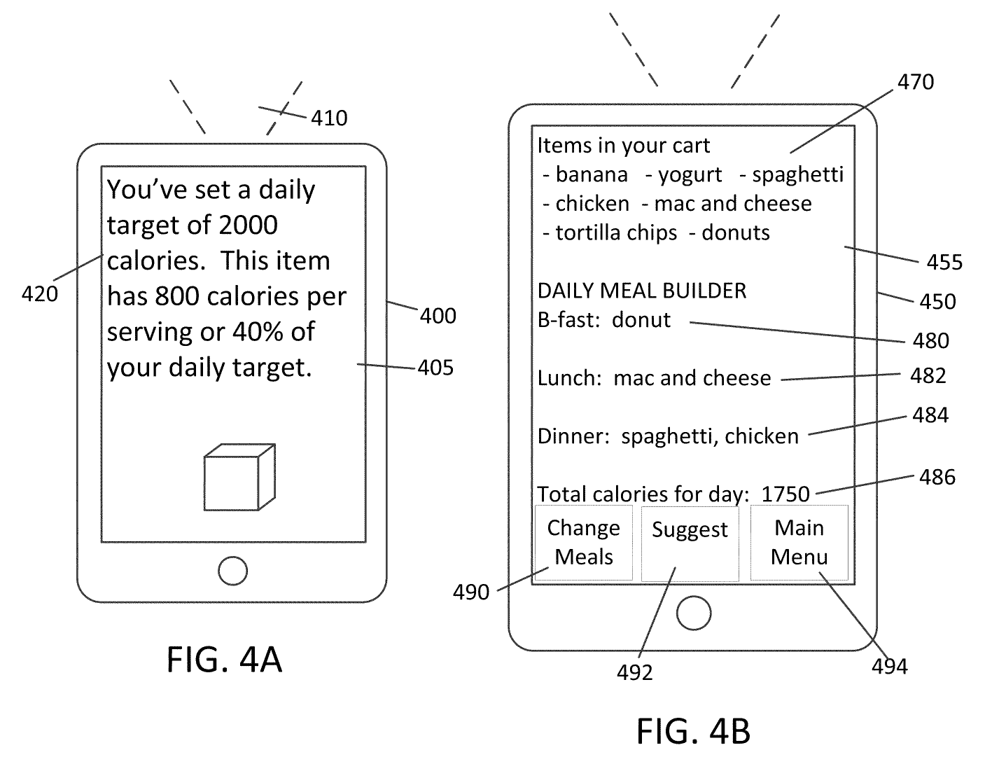

FIGS. 4A and 4B schematically illustrate exemplary portable computerized devices utilizing the processes disclosed herein. FIG. 4A is a schematic illustrating an exemplary portable computerized device embodied as a smart phone. Portable computerized device 400 includes a display 405 and a camera device including a view 410 captured by the camera. Display 405 includes message 420 including nutritional information related to a scanned product (that the product has 800 calories per serving) and information related to a dietary plan that the customer has selected or entered (a daily target for calories set at 2,000 calories). Display 405 further includes a graphic identifying the scanned item that is being discussed. FIG. 4B is a schematic illustrating an exemplary portable computerized device embodied as a tablet computer. Device 450 includes display 455 including a view 480 captured by a camera device. Device 450 has been used to scan a number of items that are presently within a shopping cart of the user. Device 450 can display a list 470 of items scanned by the user. Device 450 can further display a daily meal builder including a breakfast 480, a lunch 482, and a dinner 484, wherein the user can select items from the list of scanned items, fill the items into the meals, and get a report 486 regarding a total number of calories for the day based upon the built meals. Button 490 is provided to permit the user to change which items from the cart are assigned to each meal. Button 492 is provided for the user to request suggestions, for example, to provide for healthier results in the planned meals. Button 494 is provided to permit the device to return to a main menu, for example, facilitating scanning items and/or reviewing an electronic billing statement for the scanned items.

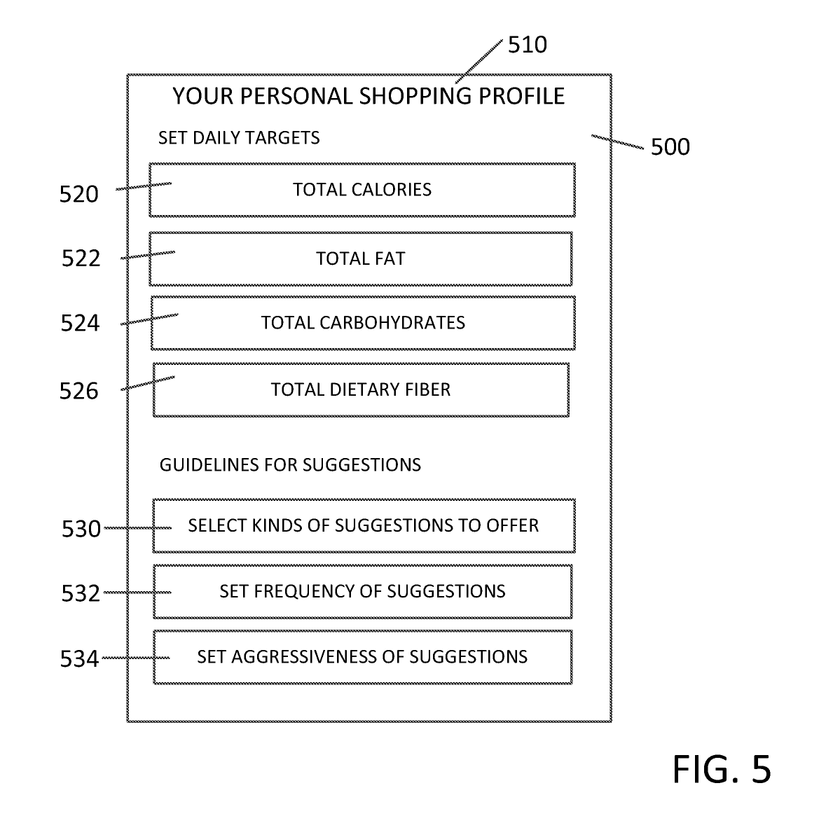

FIG. 5 is an exemplary computer display showing a customer shopping profile and various options for the customer regarding setting dietary or nutritional goals and for requesting suggestions regarding substitutions that can be made for scanned items. Display 500 includes a descriptive banner 510 identifying the displayed menu. Display 500 further includes a list of options for daily nutritional targets that the user can set. Button 520 permits the user to select a total daily calorie target. Button 522 permits the user to select a total daily fat target. Button 524 permits the user to select a total daily carbohydrates target. Button 526 permits the user to select a total daily fiber target. Display 500 further includes a list of options that the user can change controlling substitutions that the device may offer the user. Button 530 permits the user to select options regarding what kinds of suggestions or substitutions the device can offer. Exemplary options that button 530 may permit include what kinds of products can be offered to substitute another kind of product, e.g., can the device offer fruits to replace a bag of chips, and can the device make an annoying beeping sound every time an unhealthy product is scanned. Button 532 permits the user to select options regarding how frequently the device can offer suggestions. For example, the user can select that the device can offer an unlimited amount of suggestions. In another example, the user can select that the device only offer a maximum of two suggestions for every ten items scanned, thereby preventing the device from offering an intrusive number of suggestions. Button 534 permits the user to select an aggressiveness level for suggestions, for example, with a low setting only permitting occasional suggestions, with low amounts of information presented and only with products that are similar to the scanned item, and with a high setting permitting frequent suggestions including suggested substitutions of widely divergent products. A number of additional or alternative options for selection by the user related to nutritional information and substitution suggestions are envisioned, and the disclosure is not intended to be limited to the particular examples provided herein.

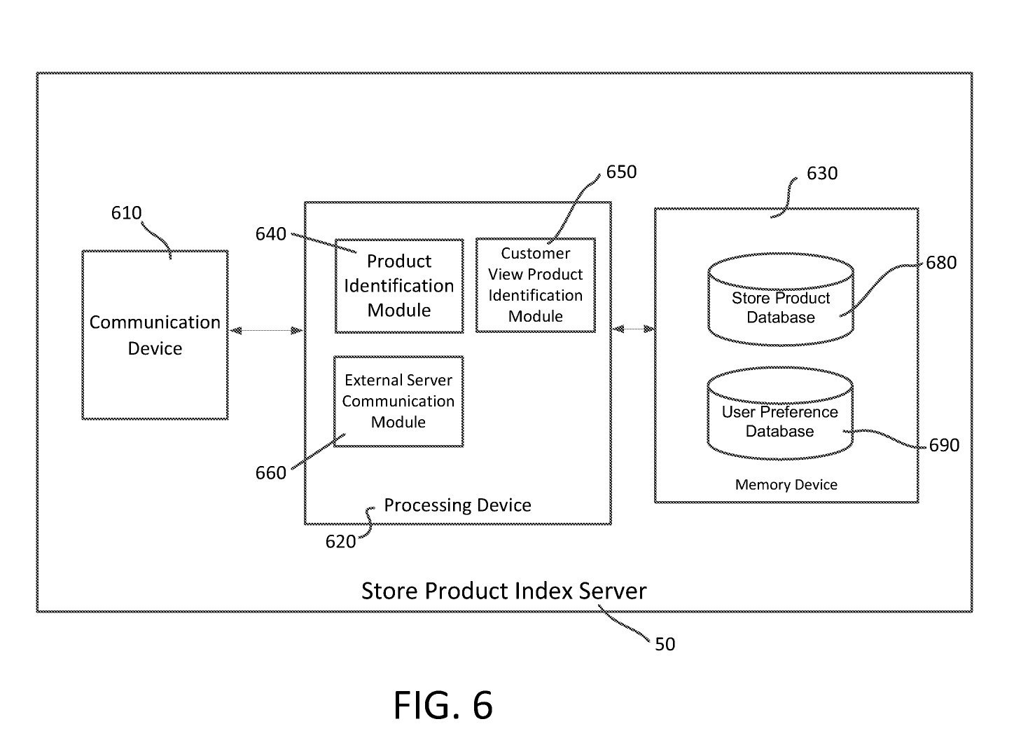

FIG. 6 is a schematic illustrating an exemplary store product index server. In the illustrated embodiment, the store product index server 50 may include a processing device 620, a communication device 610, and memory device 630.

The processing device 620 can include memory, e.g., read only memory (ROM) and random access memory (RAM), storing processor-executable instructions and one or more processors that execute the processor-executable instructions. In embodiments where the processing device 620 includes two or more processors, the processors can operate in a parallel or distributed manner. In the illustrative embodiment, the processing device 620 executes one or more of a product identification module 640, a customer view product identification module 650, and an external server communication module 660.

The communication device 610 is a device that allows the store product index server 50 to communicate with another device, e.g., a portable computerized device through a wireless communication network connection. The communication device 610 can include one or more wireless transceivers for performing wireless communication and/or one or more communication ports for performing wired communication.

The memory device 630 is a device that stores data generated or received by the store product index server 50. The memory device 630 can include, but is not limited to a hard disc drive, an optical disc drive, and/or a flash memory drive. Further, the memory device 630 may be distributed and located at multiple locations. The memory device 630 is accessible to the processing device 620. In some embodiments, the memory device 630 includes a store product database 680 and a user preference database 690.

User preference database 690 can include stored information about customers, for example, including a user's preferences for displaying nutritional information and suggested substitutions. User preferences can be stored based upon a user's name, account number, phone number, email address, or any other information that can be used to identify a unique customer. User preference database 690 can include programming to monitor suggestions and responses by the user, for example, determining substitutions or healthy products most likely to receive a positive response from the user. According to one embodiment, such adaptive processes can include machine learning algorithms known in the art.

In some embodiments, the store product database 680 stores information about a product, including nutritional information for the product, calories, carbohydrates, and other information regarding the product. The store product database 680 may further store other information about a particular product, including price, weight, availability, and similarity of the product to other available products. Store product database 680 can further include information related to items that can be suggested as substitutes for other items. In one example, store product database 680 can include lists of substitutions that are popular with customers or that are suggested by a nutrition expert for a particular product.

The product identification module 640 can monitor a product that has been scanned and reference the store product database 680 to reference, based upon a scanned image like a UPC symbol, nutritional information for the scanned product. External server communication module 660 can communicate with external servers to determine additional criteria, such as referencing published dietary or nutritional information. Product identification module 640 can include a data output module, for example, providing nutritional information for a product and information from user preference database 690, such as a nutritional target, to a portable computerized device.

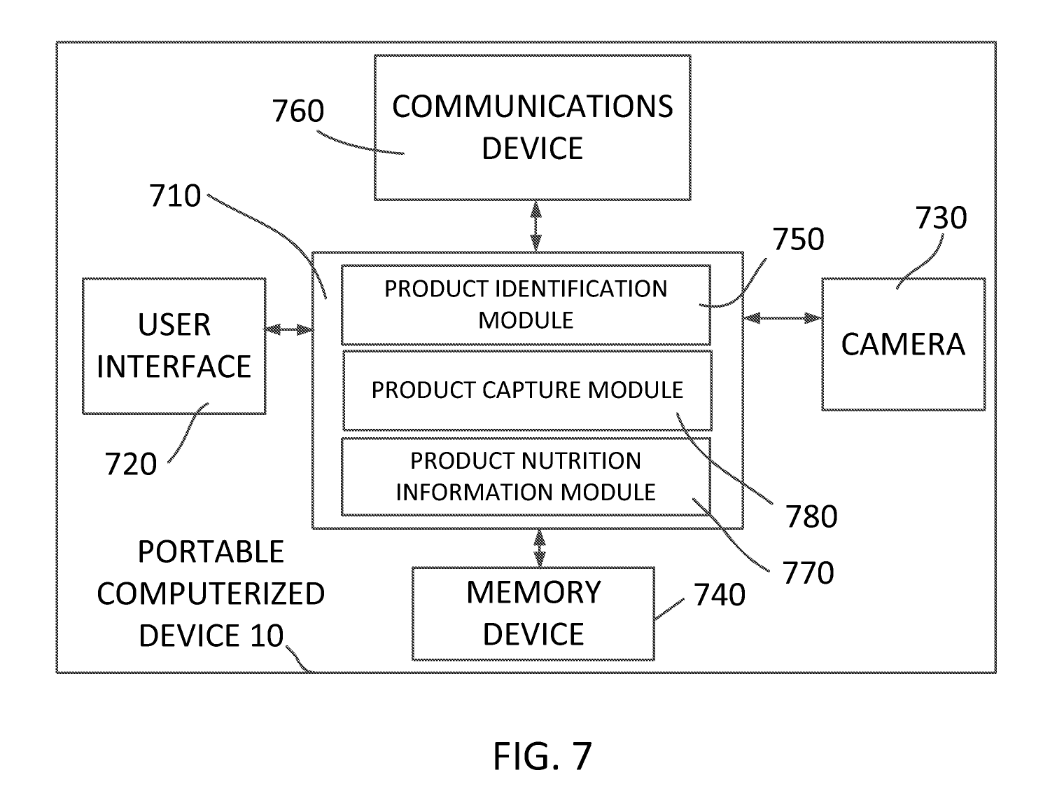

FIG. 7 is a schematic illustrating an exemplary portable computerized device configured to implement processes disclosed herein, according to some embodiment of the discloser. Device 10 includes a processing device 710, a user interface 720, a communication device 760, a camera 730, and a memory device 740.

The processing device 710 can include memory, e.g., read only memory (ROM) and random access memory (RAM), storing processor-executable memory (ROM) and random access memory (RAM), storing processor-executable instructions and one or more processors that execute the processor-executable instructions. In embodiments where the processing device 710 includes two or more processors, the processors can operate in a parallel or distributed manner. In the illustrative embodiment, the processing device 710 can execute the operating system of the portable computerized device. In the illustrative embodiment, the processing device 710 also executes a product identification module 750, a product nutrition information module 770, and a product capture module 780, which are described in greater detail below.

The user interface 720 is a device that allows a user to interact with the portable computerized device. While one user interface 720 is shown, the term “user interface” can include, but is not limited to, a touch screen, a physical keyboard, a mouse, a microphone, and/or a speaker. The communication device 760 is a device that allows the portable computerized device to communicate with another device, e.g., a store product index server. The communication device 760 can include one or more wireless transceivers for performing wireless communication and/or one or more communication ports for performing wired communication. The memory device 740 is a device that stores data generated or received by the portable computerized device. The memory device 740 can include, but is not limited to, a hard disc drive, an optical disc drive, and/or a flash memory drive.

The camera 730 is a digital camera that captures a digital photograph. The camera 730 receives an instruction to capture an image and captures an image of a view proximate to the camera. The digital photograph can be a bitmap file. The bitmap file can be a bitmap, a JPEG, a GIF, or any other suitably formatted file. The camera 730 can receive the instruction to capture the image from the processing device 710 and can output the digital photograph to the processing device 710.

Product capture module 780 monitors images captured by camera 730 and/or other inputs that can be used to indicate to a product. Product capture module 780, upon monitoring an indication to a product, uses image recognition, barcode recognition, or other processes to index the product. Information gathered by product capture module can be communicated to the product store index server to particularly identify the product according to the processes disclosed herein.

Product identification module 750 interfaces with store product index server 50, for example, to match a barcode or UPC symbol to identify a particular product associated with a scanned item. Different embodiments of the disclosure can include product identification module 750 and store product index server 50 implementing different portions of the tasks required to collect the product information as disclosed herein.

Product nutrition information module 770 can include programming to reference nutritional information for a scanned item from a remote database. Product nutrition information module 770 can further include programming to reference preferences of a user regarding nutrition and/or generic nutrition guidelines from a remote database. Product nutrition information module 770 can further include programming to compare, analyze, or otherwise provide information to the user related to nutrition and healthy choices that can be offered.

Embodiments in accordance with the present disclosure may be embodied as an device, process, or computer program product. Accordingly, the present disclosure may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present disclosure may take the form of a computer program product embodied any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

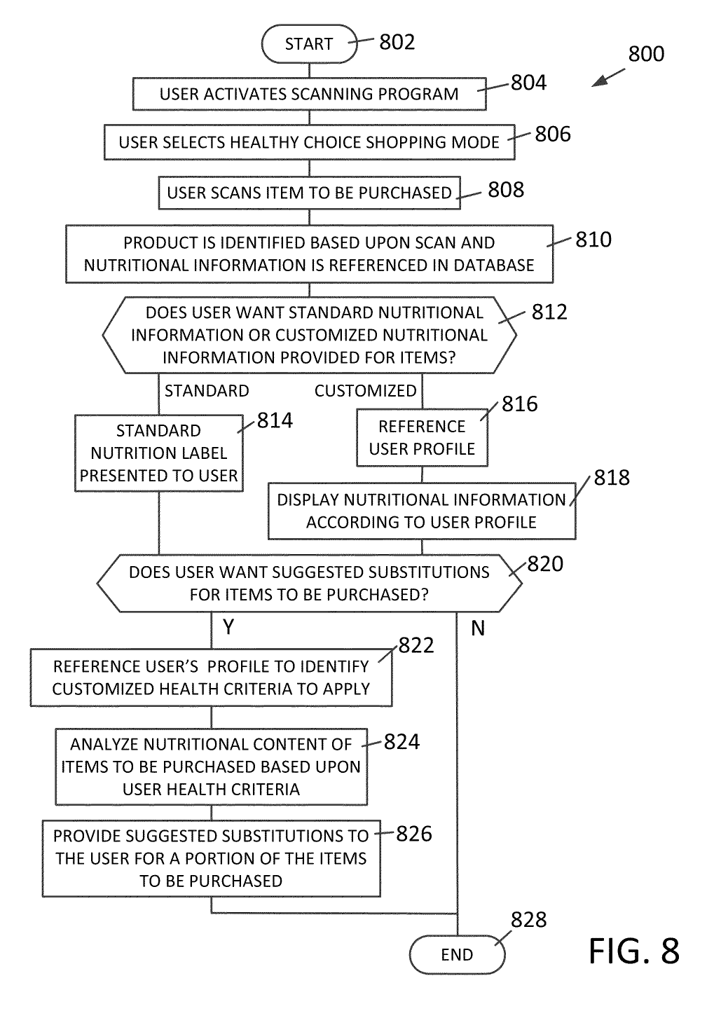

FIG. 8 is a flowchart illustrating an exemplary process to provide nutritional information and suggested substitutions to a user. Process 800 operates within a portable computerized device and begins at step 802. At step 804, the user activates a customer scan program wherein the customer uses a portable computerized device to scan items for purchase. The device can be configured to present nutritional information and/or suggested substitutions. In another embodiment, the device can include an optional healthy choice shopping mode, wherein the information and substitutions are offered only when the mode is activated. At step 806, the user selects or activates the healthy choice shopping mode. At step 808, the user scans and item to be purchased. At step 810, a product is identified based upon the scanned item, and nutritional information for the product is referenced in a remote database. At step 812, a determination is made whether the user wants standard nutritional information, for example, as is printed on consumer goods, or the user wants customized nutritional information. If the user wants standard information, then a display of a standard nutrition label or a display with the information from a standard nutrition label is provided at step 814 to the user. If the user wants customized information, then a user profile of the user is referenced at step 816 and a display of a nutritional information based upon the user profile is provided at step 818 to the user. At step 820, a determination is made whether the user wants suggested substitutions to be offered for items scanned for purchase. If the user wants suggested substitutions, then the process advances to step 822, whereat the user's profile is referenced to determine which health criteria to apply in providing suggested substitutions, e.g., reduced calorie, reduced sodium, increased dietary fiber, etc. At step 824, items scanned for purchase are analyzed based upon the referenced criteria. At step 826, suggested substitutions are presented to the user. At step 828, the process ends. The process illustrated is a non-limiting example. A number of exemplary processes are envisioned, and the disclosure is not intended to be limited to the exemplary process provided.

The flowchart and block diagrams in the flow diagrams illustrate the architecture, functionality, and operation of possible implementations of systems, processes, and computer program products according to various embodiments of the present disclosure. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing device to function in a particular manner, such that the instructions stored in the computer-readable medium produce an article of manufacture including instruction means which implement the function/act specified in the flowchart and/or block diagram block or blocks.

Hardware and software configurations of the systems disclosed herein can take many different embodiments. An augmented reality program can be installed upon a portable computerized device. In another embodiment, a portable computerized device can include an augmented reality program configured permanently to the hardware of the device. In one embodiment, a single server can be utilized remotely to provide information to a plurality of stores, with communication of necessary information being transferred over a communications network. In another embodiment, a single remotely operated personal shopping profile index server can be used to provide information for a single store. In one embodiment, a remote server can be used to provide some portion of information related to processes herein, and a second, local, in-store server can be used to provide other information and to permit local wireless communication between customers and the local server. In another embodiment, a server can be local to a store. Communication between portable computerized devices and a server can be over a cellular network, over a local network operated by the store, or by other communications processes known in the art.

The above description of illustrated examples of the present disclosure, including what is described in the Abstract, are not intended to be exhaustive or to be limitation to the precise forms disclosed. While specific embodiments of, and examples for, the disclosure are described herein for illustrative purposes, various equivalent modifications are possible without departing from the broader spirit and scope of the present disclosure. Indeed, it is appreciated that the specific example voltages, currents, frequencies, power range values, times, etc., are provided for explanation purposes and that other values may also be employed in other embodiments and examples in accordance with the teachings of the present disclosure.

1. A computer-implemented process to provide a customer with nutritional information about an item to be purchased, the process comprising:
within a processor of a portable computerized device,
receiving, from a camera of the portable computerized device, one or more images of an item offered for sale, the item having a barcode thereon;
identifying the item in the one or more images by decoding the barcode;
automatically referencing a remote database to identify nutritional information for the item;
creating a nutritional message based at least in part on the nutritional information; and
displaying simultaneously, to the customer upon a display of the portable computerized device, the nutritional message and at least one image of the one or more images with the nutritional message superimposed over the at least one image.

2. The computer-implemented process of claim 1, wherein the one or more images comprise a video stream.

3. The computer-implemented process of claim 1, wherein the creating the nutritional message comprises basing the nutritional message at least in part on a diet-related goal of the customer.

4. The computer-implemented process of claim 1, wherein the nutritional message communicates a number of calories per serving for the item.

5. The computer-implemented process of claim 1, wherein the nutritional messages inquires of the customer whether the item is to be added to a shopping cart.

6. The computer-implemented process of claim 1, wherein the nutritional message communicates a target number of calories corresponding to the customer.

7. The computer-implemented process of claim 3, wherein:
the nutritional message communicates a number of calories per serving for the item; and
the diet-related goal is a target number of calories corresponding to the customer.

8. The computer-implemented process of claim 1, further comprising referencing generic nutritional guidelines and basing the nutritional message at least in part on the generic nutritional guidelines.

9. The computer-implemented process of claim 8, wherein referencing generic nutritional guidelines comprises identifying a recommended daily calorie intake; and
wherein the nutritional message compares calories per serving for the item to the recommended daily calorie intake.

10. The computer-implemented process of claim 1, further comprising:
referencing a customized user profile including a nutritional target set by the customer;
comparing the identified nutritional information to the nutritional target; and
displaying, as part of the nutritional message, information derived from the comparing.

11. The computer-implemented process of claim 10, further comprising matching the item to be purchased to an item type;
wherein referencing the customized user profile including the nutritional target comprises referencing a target calorie count for the item type; and
wherein comparing the nutritional information to the nutritional target comprises comparing calories per serving for the item to the target calorie count for the item type.

12. The computer-implemented process of claim 1, further comprising:
automatically determining a suggested substitution for the item being purchased; and
presenting upon the display the suggested substitution for selection by the customer.

13. The computer-implemented process of claim 1, further comprising:
monitoring a plurality of scans of items to be purchased;
providing a list of the items to be purchased upon the display for assignment to meals throughout a day; and
displaying to the customer a total calorie count for the day based upon the assignment.

14. The computer-implemented process of claim 1, further comprising:
adding the item to be purchased to an electronic billing statement; and
permitting the customer to leave the store based upon the customer paying the electronic billing statement.

15. A computerized system comprising:
at least one processor; and
memory operably connected to the at least one processor, the memory comprising:
a user preference database comprising stored information about a customer including a nutritional target for the customer;
a product identification module including programming to identify a particular product based upon one or more images captured by a camera of a mobile computing device of the customer;
a store product database comprising information about the particular product including a nutritional information for the product;
a data output module programmed to create a nutritional message based at least in part on the nutritional target and the nutritional information; and
the data output module further programmed to provide simultaneously, to a display of the mobile computing device, the nutritional message and at least one image of the one or more images with the nutritional message superimposed over the at the least one image.

16. A computer system including programming to provide a customer with nutritional information about an item to be purchased, the computer system comprising:
a processor of a portable computerized device, the processor programmed to:
receive, from a camera of the portable computerized device, one or more images of an item offered for sale, the item having a code thereon;
identify the item in the one or more images by decoding the code;
automatically reference a remote database to reference nutritional information for the item;
create a nutritional message based at least in part on the nutritional information; and
display simultaneously, to the customer upon a display of the portable computerized device, the nutritional message and at least one image of the one or more images.

17. The computer system of claim 16, wherein the processor is further programmed to display simultaneously, to the customer upon the display of the portable computerized device, the nutritional message and the at least one image with the nutritional message superimposed over the at least one image.
